(19) United States
(12) Patent Application Publication
(10) Pub. No.: US 2024/0211949 A1
(43) Pub. Date: Jun. 27, 2024

(54) Multiple-Factor Authentication of Age When Making Age-Based Purchases

(71) Applicant: Capital One Services, LLC, McLean, VA (US)

(72) Inventors: Joshua Edwards, Philadelphia, PA (US); Michael Mossoba, Great Falls, VA (US); Mary Sweeny, Wilmington, DE (US)

(21) Appl. No.: 18/145,380

(22) Filed: Dec. 22, 2022

(51) Int. Cl. G06Q 20/40; G06Q 20/38

(52) U.S. Cl. CPC G06Q 20/40145; G06Q 20/384

(57) ABSTRACT

Techniques for multi-factor authentication (MFA) of an age of a user are provided. A user may request online purchase of an age-restricted product or service. The user may provide an email that is associated with metadata. The email and metadata may be processed to determine if the user is associated with the email and to determine an age of the email. The age of the email may serve as a proxy for determining a minimum age of the user. The online purchase may be authorized if the minimum age of the user meets or exceeds the minimum age required to purchase the age-restricted product or service. The age of the email may be used along with other information provided by the user to further improve or confirm an estimated age of the user. Alternative forms of personal identifiers other than email may be used such as social media handles.

### FIELD OF USE

Aspects of the disclosure generally relate to online transactions and more specifically to techniques for authorizing an online transaction based on estimation of a user's age.

### BACKGROUND

Often, online purchase of a product or service requires confirmation of a user's age. A simple conventional technique for verifying a user's age may include having the user click a button alleging that the user meets or exceeds a certain age requirement. Such a technique relies on the user providing accurate age information that can be easily circumvented by a malicious actor. As such, this conventional age verification technique may result in an age-restricted product or service being purchased by a user that does not meet minimum age requirements.

Aspects described herein may address these and other problems, and generally improve the security and reliability of online transactions of age-restricted items by providing techniques for estimating and/or verifying an age of a user.

### SUMMARY

The following presents a simplified summary of various features described herein. This summary is not an extensive overview, and is not intended to identify key or critical elements or to delineate the scope of the claims. The following summary merely presents some concepts in a simplified form as an introductory prelude to the more detailed description provided below. Corresponding apparatus, systems, and computer-readable media are also within the scope of the disclosure.

The present disclosure describes techniques for multiple-factor (multi-factor) authentication (MFA) of an age of a user when a user requests to purchase an age-restricted product or service.

To ensure that a user is of a minimum required age to purchase an age-restricted product or service, multiple different factors and/or information may be gathered to improve a determination of the user's age. Information that may be provided to estimate a user's age may include submission of a relatively old or archived email of the user. Email accounts and email correspondence associated with email accounts are often linked to users for long periods of time. As such, a relatively old email or archived email may operate as a proxy for determining an age of a user. The user may provide an email which, along with associated metadata, is processed to determine if the user is associated with the email (e.g., if the user is a sender or recipient of the email). The email and metadata may also be processed to determine an age of the email (e.g., based on a timestamp from when the email was received). A minimum age of the user may then be estimated to be the age of the email. The minimum age of the user may then be compared to the minimum required age for purchasing the age-restricted product or service to determine whether or not to authorize the online purchase. The estimated minimum age of the user based on assessing an age of the provided email may be used in conjunction with other information or techniques for confirming or determining a user's age to improve an accuracy or confidence in the estimate of the user's age. The estimated minimum age of the user may be additionally or alternatively based on processing contents of the user's email account if the user has granted permission for contents of the email account to be accessible. While the exemplary embodiments described herein relate to the use of email accounts to estimate a minimum age of the user, alternative forms of personal identifiers may be used such as, but not limited to, usernames, user IDs, social media handles, telephone numbers, etc.

These features, along with many others, are discussed in greater detail below.

### BRIEF DESCRIPTION OF THE DRAWINGS

The present disclosure is described by way of example and not limited in the accompanying figures in which like reference numerals indicate similar elements and in which:

FIG. 1 shows an example of a system in which one or more features described herein may be implemented;

FIG. 2 shows an example computing device;

FIG. 3 illustrates an example of an authentication question that may be presented to a user;

FIG. 4 shows an example of a process for determining whether to authorize purchase of an age-restricted product; and

FIG. 5 illustrates an example email that may be processed to estimate an age of a user.

### DETAILED DESCRIPTION

In the following description, reference is made to the accompanying drawings, which form a part hereof, and in which are shown various examples of features of the disclosure and/or of how the disclosure may be practiced. It is to be understood that other features may be utilized and structural and functional modifications may be made without departing from the scope of the present disclosure. The disclosure may be practiced or carried out in various ways. In addition, it is to be understood that the phraseology and terminology used herein are for the purpose of description and should not be regarded as limiting. Rather, the phrases and terms used herein are to be given their broadest interpretation and meaning.

By way of introduction, features discussed herein may relate to methods, devices, systems, and/or instructions stored on non-transitory computer-readable media for verifying or confirming an age of user to determine whether to authorize online purchase of an age-restricted product or service.

As an example, a first computing device may receive, from a second computing device operated by a user, a request to purchase an age-restricted product. The first computing device may determine, based on the request to purchase the age-restricted product, a minimum age required to purchase the age-restricted product. The first computing device may send to the second computing device a verification email address. The second computing device may cause a relatively old or archived email to be sent to the verification email address. The first computing device may receive an archived email forwarded to the verification email address. The first computing device may process metadata of the archived email to determine a time the archived email was originally sent, a time the archived email was originally received, an original sender of the archived email, and an original recipient of the archived email. The first computing device may then determine an age of the email and may generate an estimate of an age of the user based on the determined age of the email. The first computing device may determine whether to authorize the request to purchase the age-restricted product from the user based on information extracted from processing the archived email and/or the metadata associated with the email.

For example, the first computing device may determine whether the user matches at least one of the original sender of the archived email or the original recipient of the archived email; may determine a minimum age of the archived email based on at least one of the time the archived email was originally sent or the time the archived email was originally received; may determine a minimum age of the user based on the minimum age of the archived email; and/or may determine whether the minimum age of the user meets or exceeds the minimum age required to purchase the age-restricted product. The first computing device may authorize the online purchase request based on the minimum age of the user meeting or exceeding the minimum age required to purchase the age-restricted product. Alternatively, the first computing device may not authorize the online purchase request based on the minimum age of the user not meeting or exceeding the minimum age required to purchase the age-restricted product. Under either scenario of the minimum age of the user meeting or not meeting the minimum age requirement, further information from the user may be requested to further aid evaluation or estimation of the user's age. For example, the user may be requested to answer one or more knowledge-based authentication (KBA) questions and/or to provide a copy or image of an identification card or other document that indicates a birthday of the user. In this manner, the age of the email may be used as a proxy for estimating a minimum age of the user and may be used as one factor for estimating or verifying the user's age.

The techniques described herein therefore provide improved techniques for verifying an age of a user, and to more efficiently and effectively determine whether to authorize an online purchase of an age-restricted item. Age verification based on email may be supplemental to other techniques and information used to estimate the user's age and provides a simple and effective way to estimate a user's age in a manner that is easy for the user to undertake. Alternative forms of personal identifiers other than email or an email address may be used to estimate an age of an individual. For example, as described herein, personal identifiers such as, but not limited to, usernames, user IDs, social media handles, telephone numbers, etc. could be used to estimate an age of an individual.

Having introduced exemplary features, discussion will now turn to a system that may implement the exemplary features and, in particular, to a system that may use MFA of age to determine whether to authorize an online transaction.

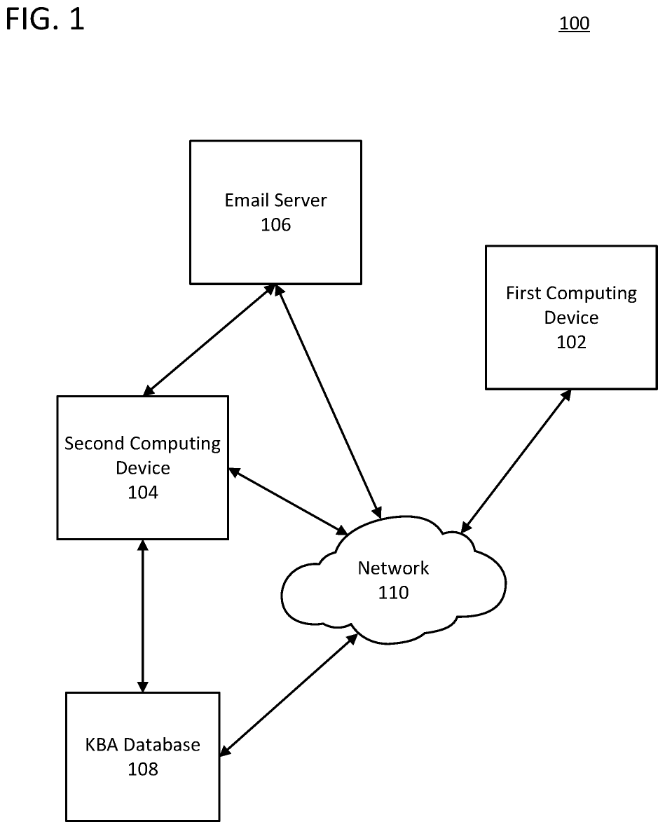

FIG. 1 illustrates a system 100 for providing multi-factor authentication (MFA) of an age of an individual according to one or more aspects of the disclosure. The system 100 may include a first computing device 102 (e.g., a user computing device), a second computing device 104, an email server 106, a knowledge-based authentication (KBA) database 108, and a network 110.

The first computing device 102 may be any type of computing device, including a mobile or a portable device. For example, the first computing device 102 may be a smartphone, a laptop, a tablet, a desktop, or an equivalent thereof. The first computing device 102 may be a wireless user computing device. The first computing device 102 may be associated with a first user that uses the first computing device 102 to browse the Internet and/or World Wide Web.

The second computing device 104 may also be any type of computing device. The second computing device 104 may include one or more computers, servers, and/or databases. The second computing device 104 may be a web server that provides and/or displays website content, for example, through storing, processing, and/or delivering webpages to users.

The second computing device 104 may be connected or coupled to the email server 106. The email server 106 may also be any type of computing device. The email server 106 may include one or more computers, servers, and/or databases. The email server 106 may store and/or process incoming email messages for distribution and/or may send out outgoing email messages.

The second computing device 104 may be connected or coupled to the KBA database 108. The KBA database 108 may store information for generation of KBA authorization questions. For example, the KBA database 108 may store popular culture information for generating a KBA question to present to a user. Popular culture information stored in the KBA database 108 may be provided based on one or more web crawlers searching the Internet for popular culture information. The popular culture information located on the Internet and stored in the KBA database 108 may be categorized based on year and/or genre. The KBA database may store correct answers to KBA questions and may store incorrect answers (e.g., false answer choices) to KBA questions.

The network 110 may be any type of communications and/or computer network. The network 110 may include any type of communication mediums and/or may be based on any type of communication standards or protocols. The network 110 communicatively couples the first computing device 102, the second computing device 104, the email server 106, and the KBA database to one another, to enable data and/or other information to be shared between the first computing device 102, the second computing device 104, the email server 106, and the KBA database 108.

The second computing device 104 may be associated with an entity or institution (e.g., a company, merchant, or store) that sells or provides various products and/or services. For example, the second computing device 104 may be associated with a “big-box” store (e.g., Ralph's Big Box Store) that sells a variety of products and/or services.

The first user may use the first computing device 102 to browse a website of the big-box store provided by the second computing device 104. The first user may use the first computing device 102 to attempt to purchase or to request to purchase a product and/or service offered by the big-box store. The product or service may be associated with age-based restrictions. For example, the first user may wish to purchase a product that may only be purchased by an individual of at least a certain age. Example age-based products and/or services include comic books, weapons, alcohol, cigarettes, videos, music, and renting a car. For certain products and/or services offered for purchase by the big-box store, an individual may be required to be at least 13 years old, 18 years old, 21 years old, or 23 years old, for example.

In general, any product and/or service offered for purchase by the big-box store through interaction with the second computing device 104 may be subject to an age-based restriction, with the associated age being any required minimum age. That is, the big-box store may offer to purchase one or more products or services that are each associated with at least one age-based restriction (e.g., a minimum age requirement). As a particular example, the first user operating the first computing device 102 may wish to purchase a rifle from Ralph's Big Box Store through a website of Ralph's Big Box Store provided by the second computing device 104, with the minimum age for purchase of the rifle being 18 years old.

To authorize the purchase of the age-restricted product by the first user, the second computing device 104 may require the first user to verify that the first user is old enough to purchase the particular age-restricted product (e.g., provide information confirming that the first user is at least as old as the minimum age required to purchase the particular age-restricted product). The second computing device 104 may request or prompt the first user to provide information to verify an age or minimum age of the first user. The first user may provide information to the second computing device 104 to confirm or verify the first user's age or minimum age.

A variety of information may be used or provided to verify and/or confirm an age of the first user. The information may include, for example, a user identification (ID) card (e.g., a driver's license), an image of the user ID card, or a picture of the user. Additional information such as, for example, the first user's responses to one or more KBA questions may be used to confirm an age of the first user. An email of the first user may also be used to verify an age of the user. The email may be an old or archived email of the first user and may serve as a proxy for determining an age of the user.

In general, any information and/or technique for verifying or confirming an age or minimum age of the first user may be used. For example, prior to authorizing the purchase of the rifle by the first user, the second computing device 104 may cause a prompt to be displayed on the first computing device 102 that instructs the first user to provide a copy or image of the driver's license ID of the first user. In response, the first user may upload via the first computing device 102 an image of the driver's license ID of the first user which is received by the second computing device 104. The second computing device 104 may process the image of the driver's license ID to determine an age of the first user (e.g., based on optical character recognition of a birthdate provided on the driver's license ID). The second computing device 104 may authorize the purchase of the rifle based on processing the image of the driver's license ID.

Alternatively, the second computing device 104 may require or request additional information to verify or confirm an age or minimum age of the first user. For example, based on an approximate age of the first user determined by processing the image of the driver's license ID, the second computing device 104 may require the first user to correctly answer one or more KBA questions generated based on data stored in KBA database 108. One or more of the KBA questions may be generated or based on an alleged or expected age of the first user. As another example, the second computing device 104 may require the first user to provide a copy of an email, with the age of the email serving as a proxy for a minimum age of the first user.

The second computing device 104 may cause a prompt to be displayed on the first computing device 102 instructing or requesting that the first user provide a copy of an email. The prompt may provide an email address for the first user to send the requested email to. The email address may be associated with the email server 106 such that, for example, an email sent to the provided email address will be received by the email server 106. In response to the prompt, the first user may cause the first computing device 102 to send an old or archived email to the email server 106.

Upon receipt of the email from the first computing device 102, the email server 106 and/or the second computing device 104 may process the email. Processing the email may include processing metadata associated with the email. The email may be processed to determine if the first user is a sender of the email or a recipient of the email (e.g., a direct recipient or is a carbon copied (cc'd) recipient or a blind carbon copied (bcc'd) recipient on the email). The email may be processed to determine a date the email was sent, a date the email was received, a date an email was opened or read, and/or a date an email was last altered. In general, any data or metadata related or associated with the email may be processed by the email server 106 or the second computing device 104 to verify that the first user at least matches a sender or recipient of the email and/or to verify an age of the email. The second computing device 104 may then operate further assuming that a determined age of the email indicates a minimum age of the first user. The metadata or other data associated with the provided email may be coded or encrypted in a manner that cannot be read by a human and must be decoded and/or decrypted by a computing device to enable information provided by the metadata and/or data to be determined. The metadata or other data associated with the provided email may also only be readable or viewable through the user of a computing device.

For example, as part of an authorization or authentication process implemented by the second computing device 104, the second computing device 104 may cause a display of the first computing device 102 to display a prompt requesting the first user send an email to an email address AGE-VERIFICATION@RALPHSBIGBOXSTORE.COM. The first user may then cause the first computing device 102 to send an email to the specified email address. The email may be stored locally in a memory of the first computing device 102. The email may be an older email of the first user. For example, the email may be an email sent or received by the first user many years ago or may be an email the first user received when registering or establishing an email account (provided by an email service provider) associated with the first user. The email server 106 may receive the email sent by the first computing device 102. The email server 106 and/or the second computing device 104 may process metadata of the email to determine that the email was originally sent by the first user on Jun. 29, 2000. The second computing device 104 may then determine that the age of the email is 22 years old and may further determine that the age of the first user is at least 22 years old (e.g., that the minimum age of the first user is 22 years old). The second computing device 104 may compare the age-based restriction associated with the purchase of the rifle (e.g., required age of at least 18 years old) to the determined minimum age of the first user (e.g., 22 years), and may determine that the minimum age of the first user exceeds the minimum age required to purchase the rifle. The second computing device 104 may then proceed to authorize purchase of the rifle.

Processing the email provided by the first computing device 102 may represent a supplemental technique or process for verifying an age of the first user, and may be part of a multi-factor process for verifying the age of the first user that may rely on a variety of information for determining the age of the first user. The second computing device 104 may authorize the purchase of an age-based restricted product or service based on processing the email from the first computing device 102 (e.g., if the age of the email is determined to meet or exceed the minimum purchase age). The second computing device 104 may not authorize or may deny the purchase of an age-based restricted product or service based on processing the email from the first computing device 102 (e.g., if the age of the email is determined to not meet or not exceed the minimum purchase age).

Alternatively, the second computing device 104 may request or require further information from the first user to determine whether to authorize purchase if the age of the email is determined to not meet or not exceed the minimum purchase age. For example, the second computing device 104 may request a second email or may request the user provide a second form of identification indicating the first user's age. In general, processing the email to determine an age of the email as a proxy for the minimum age of the first user may be used alone to verify the age of the user (and to possibly authorize purchase of the age-restricted product) or may be used as part of various other techniques and/or information for verifying the age of the first user.

Expanding on the example above, the computing device 104 may determine that an email provided by the first computing device 102 is 17 years old and that the minimum age to purchase a rifle is 18 years old. In various instances, the second computing device 104 may authorize the purchase of an age-based restricted product or service if a minimum age of the first user (as determined or indicated based on an age of an email provided by the first user) is within a threshold number of years of the required minimum age. For example, a predetermined threshold of 1 year may be set such that the second computing device 104 may authorize purchase of the rifle if the age of the email is at least 17 years old.

The predetermined threshold number of years may be set based on a variety of factors such as, for example, the type of product or service being purchased, other forms of information collected to determine an age of the first user, and/or the minimum age required to purchase the requested product or service. For example, the threshold number of years may be set relatively lower or to zero if the product is a weapon such as a rifle while the threshold number of years may be set relatively higher if the product is cigarettes or a comic book.

The threshold number of years may be adjusted based on other information provided by the first user for enabling the second computing device 104 to determine an estimated minimum age of the first user. For example, if the first user submits a driver's license ID indicating an age that exceeds the required minimum age to purchase an age-restricted product, then the second computing device may lower the threshold number of years.

The threshold number of years may be set or adjusted based on a history of the second computing device 104 interacting with a number of customers over a period of time. For example, the second computing device 104 may determine from a history of interaction with customers that the age of an email of an individual to be used as a proxy of the age of the individual is typically or on average a certain number of years younger than the actual age of the individual. This may be due to the fact that most individuals do not establish an email account until well into childhood or even later. The second computing device 104 may determine that the certain number of years is based on the actual age of the individual. This may allow the second computing device 104 to set the predetermined threshold based on an expected or alleged age of the individual and/or based on past interactions with customers of a similar age that provide emails for verification that are also similarly aged.

As part of processing the email provided by the first computing device 102, the second computing device 104 may associate the email with the first user. For example, the second computing device 104 may store information regarding the session with the first user that identifies the first user, identifies the product or service the first user wishes to purchase, and identifies the minimum age required to make the purchase. The second computing device 104 may generate a profile for the first user that may be referred to for future transactions, with the profile including an estimate of the first user's age, information provided by the first user to indicate the first user's age, and a current estimate of a minimum age of the user (e.g., based on a prior authorized or unauthorized purchase).

The second computing device 104 may be owned or controlled by an enterprise that offers for purchase the age-restricted product or service or, alternatively, may be controlled by a third-party. For example, a merchant may refer to or rely on a third-party to collect information related to the first user and to estimate an age of the first user.

Discussion will now turn to an example device that may be used to implement one or more aspects described herein.

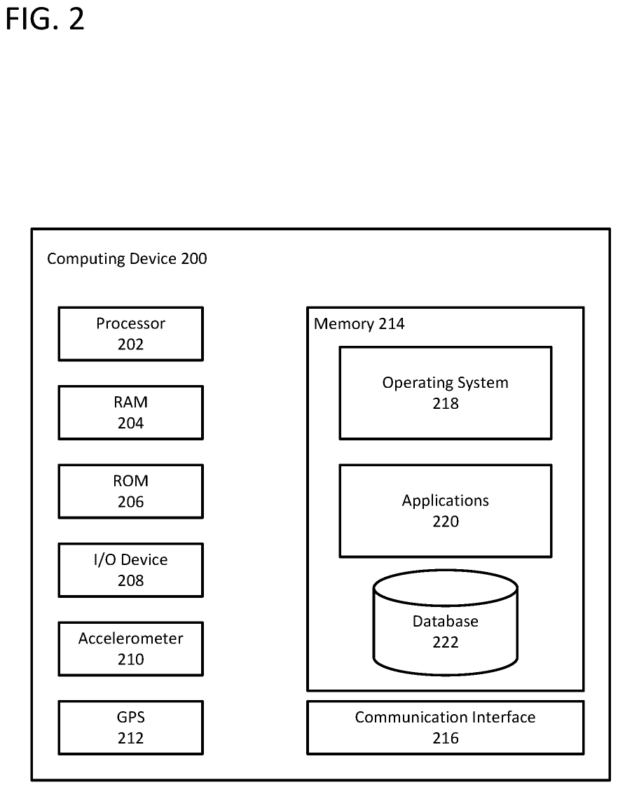

Any of the devices, components, and/or systems described herein may be implemented, in whole or in part, using one or more computing devices described with respect to FIG. 2. Turning now to FIG. 2, a computing device 200 that may be used with one or more of the computational systems is described. The computing device 200 may comprise one or more processors 202 for controlling overall operation of the computing device 200 and its associated components, including random access memory (RAM) 204, read-only memory (ROM) 206, input/output device 208, accelerometer 210, global-position system (GPS) antenna 212, memory 214, and/or communication interface 216. A bus (not shown in FIG. 2 for simplicity) may interconnect processor(s) 202, RAM 204, ROM 206, I/O device 208, accelerometer 210, global-position system receiver/antenna 212, memory 214, and/or communication interface 216. Computing device 200 may represent, be incorporated in, and/or comprise various devices such as a desktop computer, a computer server, a gateway, a mobile device, such as a laptop computer, a tablet computer, a smartphone, any other types of mobile computing devices, and the like, and/or any other type of data processing device.

Input/output (I/O) device 208 may comprise a microphone, keypad, touch screen, and/or stylus through which a user of the computing device 200 may provide input, and may also comprise one or more of a speaker for providing audio output and a video display device for providing textual, audiovisual, and/or graphical output. Software may be stored within memory 214 to provide instructions to processor 202 allowing computing device 200 to perform various actions. For example, memory 214 may store software used by the computing device 200, such as an operating system 218, application programs 220, and/or an associated internal database 222. The various hardware memory units in memory 214 may comprise volatile and nonvolatile, removable and non-removable media implemented in any method or technology for storage of information such as computer-readable instructions, data structures, program modules, or other data. Memory 214 may comprise one or more physical persistent memory devices and/or one or more non-persistent memory devices. Memory 214 may comprise RAM, ROM, electronically erasable programmable read only memory (EEPROM), flash memory or other memory technology, optical disk storage, magnetic cassettes, magnetic tape, magnetic disk storage or other magnetic storage devices, or any other medium that may be used to store the desired information and that may be accessed by processor 202.

Accelerometer 210 may be a sensor configured to measure accelerating forces of computing device 200. Accelerometer 210 may be an electromechanical device. Accelerometer 210 may be used to measure the tilting motion and/or orientation computing device 200, movement of computing device 200, and/or vibrations of computing device 200. The acceleration forces may be transmitted to the processor 202 to process the acceleration forces and determine the state of computing device 200.

GPS receiver/antenna 212 may be configured to receive one or more signals from one or more global positioning satellites to determine a geographic location of computing device 200. The geographic location provided by GPS receiver/antenna 212 may be used for navigation, tracking, and positioning applications. In this regard, the geographic may also include places and routes frequented by the first user.

Communication interface 216 may comprise one or more transceivers, digital signal processors, and/or additional circuitry and software, protocol stack, and/or network stack for communicating via any network, wired or wireless, using any protocol as described herein.

Processor 202 may comprise a single central processing unit (CPU), which may be a single-core or multi-core processor, or may comprise multiple CPUs. Processor(s) 202 and associated components may allow the computing device 200 to execute a series of computer-readable instructions (e.g., instructions stored in RAM 204, ROM 206, memory 214, and/or in other memory of computing device 200) to perform some or all of the processes described herein. Although not shown in FIG. 2, various elements within memory 214 or other components in computing device 200, may comprise one or more caches, for example, CPU caches used by the processor 202, page caches used by the operating system 218, disk caches of a hard drive, and/or database caches used to cache content from database 222. A CPU cache may be used by one or more processors 202 to reduce memory latency and access time. A processor 202 may retrieve data from or write data to the CPU cache rather than reading/writing to memory 214, which may improve the speed of these operations.

In some examples, a database cache may be created in which certain data from a database 222 is cached in a separate smaller database in a memory separate from the database 222, such as in RAM 204 or on a separate computing device. For example, in a multi-tiered application, a database cache on an application server may reduce data retrieval and data manipulation time by not needing to communicate over a network with a back-end database server. These types of caches and others may provide potential advantages in certain implementations of devices, systems, and methods described herein, such as faster response times and less dependence on network conditions when transmitting and receiving data.

Although various components of computing device 200 are described separately, functionality of the various components may be combined and/or performed by a single component and/or multiple computing devices in communication without departing from the disclosure.

Discussion will now turn to an exemplary KBA question that may be presented to a user.

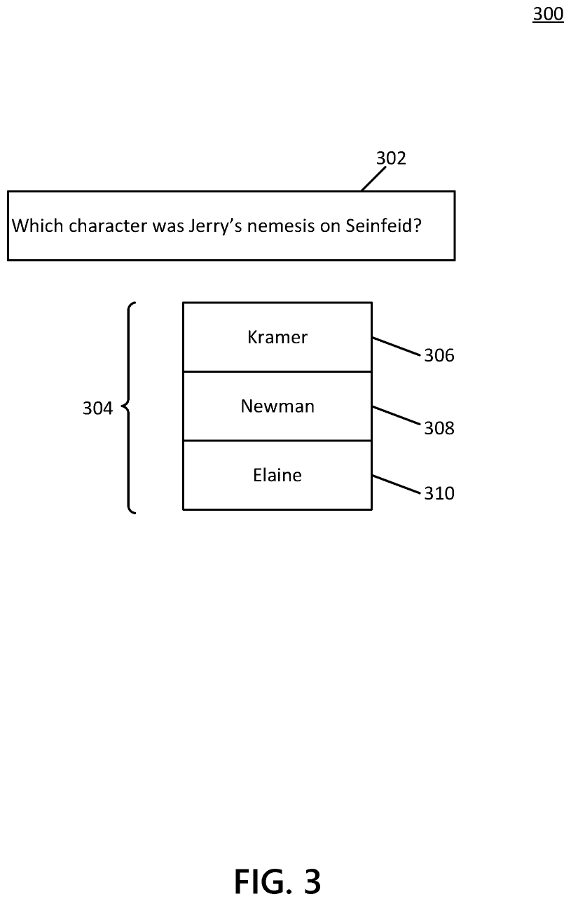

FIG. 3 illustrates an example of a knowledge-based authentication (or authorization) question 300 that may be presented to a user (e.g., the first user associated with the first computing device 102) according to one or more aspects of the disclosure. The authentication question 300 may be presented in any manner to the first user. The authentication question 300 may be presented to the first user via a display screen (e.g., a display screen or touchscreen of the first computing device 102). The authentication question 300 may be presented to the first user audibly (e.g., via a speaker of the first computing device 102).

The authentication question 300 may be generated by the second computing device 104 based on information stored in the KBA database 108. The authentication question 300 may be generated based on an estimated age of the first user of the first computing device 102. For example, the first user of the first computing device 102 may provide an image of a driver's license ID for the first user to the second computing device 104. The second computing device 104 may process the image of the driver's license ID for the first user to determine an estimated age of the first user. To confirm the age of the first user, the second computing device may generate the authentication question 300 to ask for an answer to a popular culture question that a person of the same estimated age of the first user would likely be able to understand and answer correctly.

For example, if the estimated age of the first user is 46 years old, then the second computing device 104 may generate the authentication question 300 to be directed to popular culture the first user is likely to be familiar with from the 1990s. Information for generating the authentication question 300 may be collected from the Internet using one or more web crawler algorithms that search for and collect popular culture information based on the first user's estimated age and/or gender (e.g., as determined based on the driver's license of the first user and/or based on other information provided by the user).

The authentication question 300 may include a prompt 302. The authentication question 300 may further include a set of possible answers 304. Answers 306 and 310 may be false answer choices while answer 308 may be the correct answer. The second computing device 104 may generate the answers 304 based on information stored in the KBA database. The first user may provide an answer to the authentication question 300. The first user may provide an answer in a variety of manners including, for example, providing an audible response to the authentication question 300 or selecting one of the answers 304 by touching a touchscreen of the first computing device 102, thereby causing a signal indicating the response of the first user to be provided to the second computing device 104.

The second computing device 104 may evaluate an answer to the authentication question 300 provided by the first user. The second computing device 104 may compare the response to a designated correct answer to the authentication question 300 to determine if the first user responded correctly or incorrectly. If the first user responded correctly, the second computing device 104 may use such a result to further inform the authentication or authorization process (e.g., the second computing device 104 may authorize the purchase of an age-restricted product). Determining that the first user responded correctly may influence what further information the second computing device 102 may request from the first user to assess an age of the first user. If the first user responded incorrectly, the second computing device 104 may not authorize the purchase of an age-restricted product.

Discussion will now turn to an exemplary process for verifying an age of a user based on an age of an email.

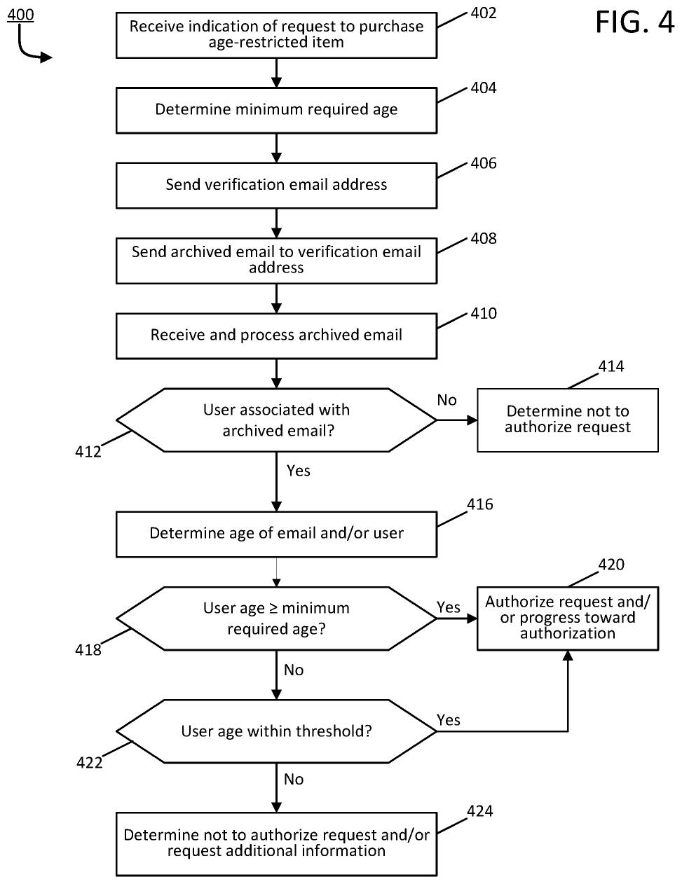

FIG. 4 shows a flow chart of a process 400 for determining whether to authorize purchase of an age-restricted product. The process 400 is described in relation to a user wishing to purchase an age-restricted product but is applicable to techniques for determining whether to authorize purchase of an age-restricted service (e.g., renting a car). The process 400 may represent a portion of a process for authorizing purchase of an age-restricted product based on determining a minimum age of a user based on an email. The process 400 may be used in conjunction with or as part of a larger process that collects other information to determine an estimate of a user's minimum age as described herein.

Some or all of the steps of process 400 may be performed using one or more computing devices (e.g., an application executing on a computing device) as described herein, including, for example, a client device, a server, or a memory and a processor configured to perform the methods described herein. For example, any portion of the process may be performed using the first computing device 102 of FIG. 1, the second computing device 104 of FIG. 1, the email server 106 of FIG. 1, the KBA database of FIG. 1, or the computing device 200 of FIG. 2.

In step 402, a request to purchase an age-restricted product may be received from a user. The age-restricted product may be any type of product. The request may be sent by a first computing device (e.g., the first computing device 102) operated by the user. The request may identify the age-restricted product and/or may indicate a desire of the user to purchase the age-restricted product. The request may be received by a second computing device (e.g., the second computing device 104). The second computing device may be operated by an entity or business offering the age-restricted product for sale. The second computing device may be operated by another party (e.g., a third party entity or business) that provides a service of collecting and evaluating information to determine a minimum age of a user wishing to purchase an age-restricted product. The request may be received via a web server of an entity that offers for sale the age-restricted product. The web server and/or one or more affiliated computers or servers may process the request.

In step 404, a minimum age required to purchase the age-restricted product may be determined. The minimum age required to purchase the age-restricted product may be determined by the second computing device. The minimum age required to purchase the age-restricted product may be determined based on an indication of the age-restricted product in the request from the first computing device and/or may be based on information stored in one or more databases that correlates age-restricted products with minimum ages required for purchasing a particular age-restricted product.

In step 406, a verification email address may be sent to the user. The verification email address may be sent to the first computing device from the second computing device or from an email server associated with the second computing device (e.g., the email server 106). The verification email address may be provided to the first computing device via an email communication for example, based on an email address provided by the user. The verification email address may be provided to the first computing device by the second computing device causing the first computing device to display the verification email address on a display of the first computing device. The display may include a prompt stating that the second computing device (and/or entity or business selling the age-restricted product) is requesting or instructing the user to provide an email that may be used to estimate the age of the user. The display may provide the verification email address and may provide instructions for sending the email to the second computing device, the email server, and/or to another computing device associated with the entity or business offering the age-restricted product for purchase or sale.

In step 408, the first computing device may send an email to the specified verification email address. The user may operate the first computing device to locate the email to be sent. The email may be stored locally in a memory of the first computing device or may otherwise be accessible to the first computing device. The email may be stored on a remote email server and hosted and/or managed by another third party (e.g., a third party email service). The first computing device may cause an email stored on a remote email server to be sent to the email verification address.

The first computing device may also indicate through interaction with the email server and/or the second computing device a source of the email that is being sent to the email verification address. In doing so, the email server and/or the second computing device may take steps to ensure the email is received and not blocked through any malicious filtering tool or spam filtering tool. For example, a user operating the first computing device may indicate to the second computing device a type of email being sent (e.g., the email service provider or the email address of the user). The email provided by the user may be considered to be an old email or an archived email. The user may interact with an app operating on the first computing device or may interact with a webpage to facilitate sending the email and to facilitate indication of a source of the email such that the email may be received for processing.

In step 410, the email provided by the user is received and processed. The email may be received and/or processed by the email server and/or the second computing device. As an example, the email server may receive the email and may provide the email to the second computing device for processing. The email may be processed by associating the email to a current session of the user and the entity or business offering the age-restricted product for purchase. The email may also be processed to associate the email to the particular user and to the particular age-restricted product the user wishes to purchase. Further, the email may be processed to detect any contents of the email and/or to process any metadata associated with the email.

Information within the archived and/or metadata associated with the archived email may be processed to determine a time the archived email was originally sent, a time the archived email was originally received, an original sender of the archived email, and/or an original recipient of the archived email. A computing device may be required to render a visual display of the contents of the email and/or to access (or decode) information provided by the metadata (e.g., in order to access and use any information indicated by the metadata).

In step 412, information associated with the email (e.g., as determined or detected based on processing the contents of the archived email and/or by processing the metadata associated with the archived email) may be compared to the user making the request to purchase the age-restricted purchase. For example, the second computing device may compare information associated with the archived email to the user to determine if an identify of the user matches a sender of the email (e.g., an original sender of the email) or a recipient of the email (e.g., an original recipient of the email including CC and BCC original recipients of the archived email). In this manner, it may be determined if the user is associated with the archived email.

An identity of the user may be based on information provided by the user via the first computing device. For example, the user may provide login credentials to the second computing device or other identifying information that may allow the second computing device to associate the user with a profile of the user that identifies the user (e.g., by name, address, order history, etc.). The user may also provide a copy of driver's license ID that may also be used to determine or at least inform a determination as to an identity of the user.

Process 400 may proceed to step 414 if it is determined that the user is not associated with the archived email. For example, process 400 may proceed from step 412 to 414 if it is determined that the user is not an original sender or an original recipient of the archived email. At step 414, the process 400 may end with a determination (e.g., by the second computing device) not to authorize the purchase of the age-restricted product. Alternatively, the process 400 may continue with the second computing device requesting another email from the user that may be used to estimate a minimum age of the user and/or may continue with the second computing device requesting other information from the user that may be used to estimate a minimum age of the user (e.g., a copy of a driver's license ID, information regarding purchases of similar age-restricted items, etc.).

Process 400 may proceed to step 416 if it is determined that the user is associated with the archived email. For example, process 400 may proceed from step 412 to 416 if it is determined that the user is an original sender or an original recipient of the archived email. At step 416, a determination as to a minimum age of the user may be made. The determination of the minimum age of the user may be based on a determination of a minimum age of the archived email. The minimum age of the archived email may be based on processing contents of the archived email and/or metadata associated with the archived email. For example, the archived email may indicate an original date for sending or receiving the email that may be used to estimate a minimum age of the email. A timestamp of the email provided either in the contents or body of the email and/or provided as metadata associated with the email may indicate an original date of sending and/or receiving the email.

The archived email, for example, may be associated with metadata that indicates that the email was originally received by the user on Jun. 29, 2000. The second computing device may determine that the minimum age of the email is 22 years. Further, the second computing device may also determine that the user is at least 22 years old (e.g., the minimum age of the user is 22 years old). In this manner, an estimated age of the email may be used to estimate an age of the user (e.g., the age or minimum age of the email may serve as a proxy for determining or estimating an age or minimum age of the user).

A user may grant access to the user's email account and its contents. For example, a user may give (e.g., to the second computing device 104) read access to the contents of the user's email account via Open Authorization (OAuth). By granting access to the contents of the user's email account, a historical analysis of the user's emails may be conducted to facilitate estimation of an age of the user. If the user has granted access to the contents of the user's email account, then in step 416, any content of the user's email account may be analyzed to further develop an estimate of the age of the user (e.g., in conjunction with determining an age of an archived email provided by the user).

Analysis of any content of the user's email account may involve processing the content using optical character recognition (OCR) and/or processing the content using one or more natural language processing (NLP) algorithms. Analysis of any content of the user's email account may also or alternatively involve determining a reading score or level associated with the content. The content accessible for analysis may be an email (e.g., a sent, received, deleted, or draft email correspondence) and/or may be any attachment to an email.

As an example, an age of an email account may be determined in step 416 to be 17 years old, based on an archived email provided by the user as described herein. Contents of the user's email account may be analyzed to determine that the account has been largely inactive or dormant for a number of years (e.g., 8 years) and then becomes active with emails to mostly grandparents. Based on processing contents of the user's email account, it may be determined that the email account was established (e.g., opened) on behalf of the user when the user was a baby and/or was first born. As such, it may be determined that the user is likely to be approximately 17 years old (e.g., matching an age of the email account).

As another example, an age of an email account may be determined in step 416 to be 3 years old, based on an archived email provided by the user as described herein. Contents of the user's email account may be analyzed to determine that the account includes various correspondence with various entities (e.g., employer, universities, tax agencies, etc.) that indicate the user is significantly older than the age of the email account. Based on processing contents of the user's email account, it may be determined that the email account was established (e.g., opened) when the user was a teenager. As such, it may be determined that the user is likely to be 18 years old or older based on the mature topics contained in the contents of the user's email account.

Attachments may be processed using OCR techniques and/or NLP algorithms to determine the manner in which the user has filled out documents with birthdate information indicating an age of the user. For example, an archived email may indicate that the user's email account is only 10 years old while employment applications available within the email account may be processed to determine that the user has repeatedly and consistently filled out documents with birthdate information indicating a specific age of the user. As a particular example, the contents of the user's email account may be analyzed to determine a first employment application filled out by the user and a second employment application filled out by the user. The first employment application and the second employment application may have been emailed from the user to the prospective (e.g., different) employers. The first employment application and the second employment application may be processed to determine that the user indicated his birthdate to be Aug. 1, 2002 on both documents. As such, it may be determined that the user is likely to be 20 years old. In general, any content of the user's email account may be processed and analyzed in step 416 to facilitate an estimate of the user's age in conjunction with any determination as to the age of the user's email account.

In step 418, a determination may be made as to whether an estimated minimum age of the user meets or exceeds the minimum age required to purchase the age-restricted product. The determination may be made by the second computing device. The estimated minimum age of the user may be based on process and/or operations associated with step 416. The determination may be based solely on a determination of a minimum estimated age of an old or archived email provided by the user and/or may be supplemented by other information (e.g., the user answering a KBA question and/or providing a copy of a driver's license ID). Alternatively or in addition thereto, the determination may be based on processing contents of the user's email account as described herein if the user has granted read access to the contents of the account. The estimated minimum age of the user from step 416 may be compared to the age for purchase of the age-restricted product determined in step 404.

Process 400 may proceed to step 420 if it is determined the minimum age of the user meets or exceeds the minimum age required to purchase the age-restricted product. For example, process 400 may proceed from step 418 to 420 if it is determined that the estimated minimum age of the user is 23 years old (e.g., based on a determination that an estimated age of an email provided by the user is 23 years old) and that the minimum age to purchase the age-restricted product is 18 years old. At step 420, the purchase of the age-restricted product may be authorized and a transaction for purchase of the product may be conducted. Alternatively, at step 420, the determination that the minimum age of the user meets or exceeds the minimum age to purchase the product may be information or an indicator provided to another process or a further process that uses multiple factors for determining or estimating an age of the user and determining whether or not to authorize purchase of the age-restricted product. For example, the determination from step 418 may feed into other processes that verifies age according to other MFA techniques.

Process 400 may proceed to step 422 if it is determined the minimum age of the user does not meet or exceed the minimum age required to purchase the age-restricted product. For example, process 400 may proceed from step 418 to 422 if it is determined that the estimated minimum age of the user is 17 years old (e.g., based on a determination that an estimated age of an email provided by the user is 17 years old) and that the minimum age to purchase the age-restricted product is 18 years old. At step 422, a determination may be made as to whether the estimated minimum age of the user (e.g., based on a determination that an estimated age of an email provided by the user) is within a predetermined threshold number of years to a minimum age required to purchase the age-restricted product.

For example, the predetermined threshold may be a threshold of 1 year, such that purchase of the product may be authorized if an age of an email is within 1 year of the minimum age required to purchase the product. As a specific example, the user may wish to purchase a product for which the minimum age to do so is 18 years. The user may have provided an archived email that is determined to be 17 years old. Based on the predetermined threshold number of years being set to 1 year, it may be determined that the minimum age of the user is likely older than 17 (e.g., older than 18) such that purchase of the product may be authorized. In such a manner, the process 400 may proceed to step 420.

The predetermined threshold number of years may be set or adjusted in a variety of manners as discussed herein. For example, the threshold may be set based on the type of product or service the user wishes to purchase. The threshold may be set based on an alleged age of the user. The threshold may be set based on interactions with other customers. For example, a history of interactions with other users or customers may indicate that users typically are 3-5 years older (or any age older) than an age of an archived email they provided, for example, based on a particular type of product or service being purchased. A history of interactions with various customers that may involve determining an actual age of the customers as compared to emails provided by the customers may be used to determine a typical or average age gap between email age and user actual age.

As another example, machine learning (ML) models, techniques, or algorithms may be used to set or adjust the predetermined threshold. A ML model may be trained on data that may include old or archived emails of users and may include actual ages of individuals associated with the emails. The ML model may be trained based on the emails and user ages to develop an estimate of an actual age of a user for a given email age. The ML model may consider or be trained on other data or factors such as, for example, the item being purchased or a gender of the user. Based on one or more such ML models, an estimate for the predetermined threshold may be determined. For example, the ML model may determine that the actual age of a user is generally or on average 5 years older than an oldest age of the email provided by a user. This may allow a predetermined threshold to be set at 5 years or perhaps 4 years.

Process 400 may proceed to step 424 if it is determined that the minimum age of the user is not within the threshold number of years to the minimum age required to purchase the age-restricted product. In step 424, it may be determined to not authorize purchase of the age-restricted product. Alternatively, in step 424, it may be determined to request additional information from the user to further evaluate whether or not to authorize purchase of the product. The further information may be used to generate a further or refined estimate of a minimum age of the user which may then be used (e.g., with any other age related information determined for the user) to determine if authorization of the purchase should be provided.

For example, in step 424, the second computing device may send a request for additional information to the first computing device. The request for additional information may be considered to be a request for supplemental information that may be used to estimate an age of the user. The supplemental information may include an image of an identification card (e.g., a driver's license ID) for the user. The supplemental information may include an image of the user (e.g., captured by a web camera). An image of the user via an ID card or an image of the user directly captured in front of a user device (e.g., captured based on a camera of a smartphone) may be processed using one or more facial recognition algorithms. The facial recognition algorithms may operate to identify the user (e.g., or match the user to an alleged individual) and/or may operate to estimate an age of the user based on facial features.

The supplemental information may include responses by the user to one or more KBA questions posed to the user. The KBA questions may be generated by the second computing device for presentation to the user via the first computing device. The KBA questions may be generated based on alleged or expected age of the user and may be generated based on information stored in one or more databases (e.g., the KBA database 108). The KBA questions presented to the user may be displayed as shown in relation to FIG. 3. One or more web crawler algorithms may be used to search the Internet or other sources for popular culture trivia questions and answers to develop the KBA questions. Responses to the KBA questions may be used to further evaluate and/or estimate an age of the user.

The supplemental information may include requests for one or more social media posts made by the user. In response, the user may provide or may direct the second computing device to one or more social media posts authored by the user. The social media posts may be old or archived social media posts authored by the user when the user was an alleged age. An age of the social media posts may be confirmed or verified to assess an age of the user. Further, information provided in the social media posts may be used to estimate an age of the user. For example, the user may provide a social media post that is alleged to be a certain number of years old or is alleged to have been made by the user when the user was a certain age. An expected age of the social media post may be determined. Further, one or more readability level algorithms may be applied to the contents of the social media post to assess a reading level of the person who posted the social media post. In this manner, an estimate of an age of the person at the time of posting the message may be estimated and extrapolated to generate an estimate of the user's current age.

For example, the user may provide a link to a social media post. The user may allege that the social media post was made 10 years ago when the user was allegedly 11 years old, such that the user now alleges she is 21 years old. Based on applying one or more readability algorithms to the contents of the post (e.g., based on a Flesch-Kincaid readability level determination), it may be determined that the post was authored by someone who is no older than 8 years old, making the user currently only 18 years old. In this manner, readability levels of individuals making social media posts (or other authored content such as articles, web pages, reviews, commentary, etc.) may be determined to further evaluate an age of a user.

The steps of process 400 may be implemented in any order and are not limited to being implemented in the order shown or as discussed herein. For example, process 400 may be implemented by first requesting a user provide a copy of a driver's license ID and then implementing steps to request the user provide an email to supplement age information that may be determined from the driver's license ID.

While FIG. 4 described the use of an email account to estimate a minimum age of a user, alternative forms of personal identifiers may be used such as, but not limited to, usernames, user IDs, social media handles, telephone numbers, etc. FIG. 4 is therefore not limited to the use of an email account but may use any type of personal identifier to estimate an age of a user. As an example, a user may provide a username, user ID, handle, or other identifier that may be used to identify a user's online or social media presence. The systems and methods described herein could use such identification information to estimate an age of the user's online or social media presence (e.g., a number of years a particular social media account has been active) which may be used to estimate an age of the user. In this manner, various available resources could be used to estimate an age of the user including Twitter handles, Instagram accounts, SMS messages, iMessages, or other available information. Accordingly, in response to a request for information about a user to establish an estimate of the user's age, the user may respond with a social media account of the user and the systems and method described herein may review the user's personal identifier, social media account, other users' social media accounts, web crawlers, etc. to estimate how long the user has had the social media account. This may allow an estimate of an age of the user to be determined and used to determine whether a user meets or exceeds a minimum age to purchase an age-restricted product as described herein.

Discussion will now turn to an example processing of an email to determine an age of an email and its association to a particular user.

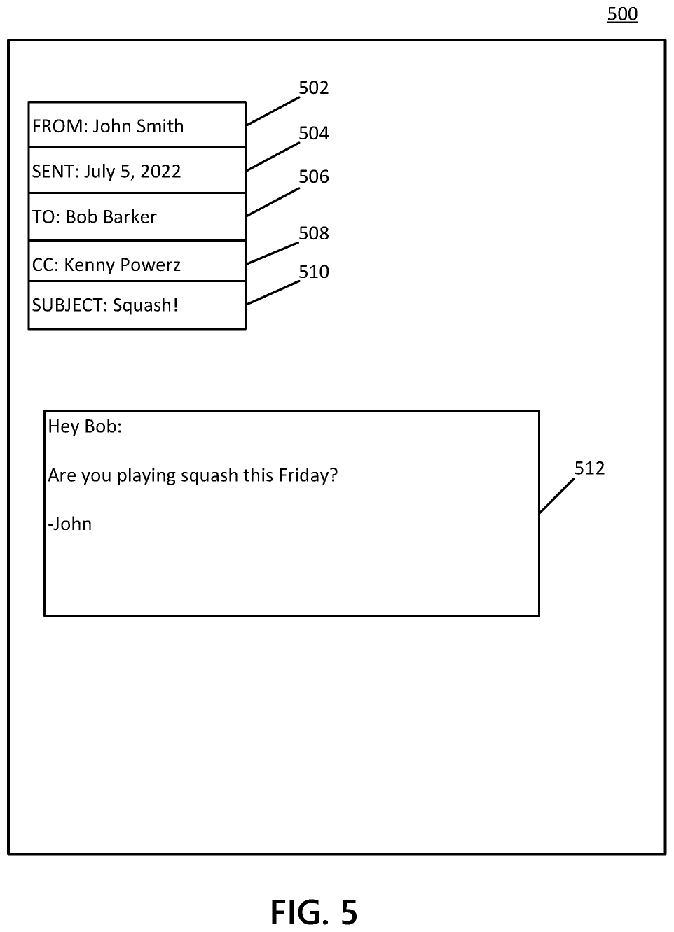

FIG. 5 illustrates an example email 500 that may be used to estimate an age of a user. The email 500 may show the contents of the email that are displayed when presented within an email application. Other data associated with the email 500 such as, for example, metadata may not be displayed within the email 500 when viewed and may be processed separately from the displayed contents of the email 500.

As shown in FIG. 5, the email 500 includes a “From” field 502, a “Sent” field 504, a “To” field 506, a “CC” field 508, a “Subject” field 510, and a body 512. The “Sent” field may include a timestamp (or other date/time information) indicating when the email 500 was originally sent. The email 500 may be processed by parsing the different parts and/or fields of the email message 500 and/or by character recognition processing to understand the text contained in the email 500. The email 500 may be processed to determine if the user that provided the email 500 matches either the sender (e.g., “John Smith”) or one of the recipients (e.g., “Bob Barker” or “Kenny Powerz”). For example, the email 500 may have been provided by John Smith. Under such a scenario, it may be determined that the email is indeed associated with the user since the “To” field 502 indicates that the sender was John Smith.

The email 500 may also be processed to determine a time the email was sent or received. For example, the email 500 may be processed to identify the “Sent” field 504 and to determine a year associated with the “Sent” field. It may be determined that the email was sent at least 20 years ago based on the year and/or date provided in the “Sent” field 504 (e.g., based on a timestamp provided in the “Sent” field 504). The minimum age of the email may then be determined to be at least 20 years old. The age of the email, as described herein, may also serve as a proxy for an age of the user that provided the email such that a minimum age of the user is also determined to be at least 20 years old. This determined age of the user may be information used to either authorize or block a transaction for an age-restricted product or service and/or may be used as a portion of a larger set of information used to estimate an age of the user and to authorize or block the transaction.

Techniques described herein for MFA of age may include processing an email and/or metadata of an email to estimate an age of a user. As it is common for individuals to maintain access to emails for many years, MFA of age techniques as described herein that rely on relatively old or archived emails being provided by a user are quick and efficient manners to estimate an age of the user. Such techniques as described herein are not cumbersome on the user and can be implemented with ease by the user. This allows the purchase process by the user to remain relatively simple and quick, thereby improving the user shopping experience while increasing a likelihood that the user is indeed of a required age to purchase an age-restricted item.

One or more features discussed herein may be embodied in computer-usable or readable data and/or computer-executable instructions, such as in one or more program modules, executed by one or more computers or other devices as described herein. Program modules may comprise routines, programs, objects, components, data structures, and the like. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid-state memory, RAM, and the like. The functionality of the program modules may be combined or distributed as desired. In addition, the functionality may be embodied in whole or in part in firmware or hardware equivalents such as integrated circuits, field programmable gate arrays (FPGA), and the like. Particular data structures may be used to more effectively implement one or more features discussed herein, and such data structures are contemplated within the scope of computer executable instructions and computer-usable data described herein. Various features described herein may be embodied as a method, a computing device, a system, and/or a computer program product.

Although the present disclosure has been described in terms of various examples, many additional modifications and variations would be apparent to those skilled in the art. In particular, any of the various processes described above may be performed in alternative sequences and/or in parallel (on different computing devices) in order to achieve similar results in a manner that is more appropriate to the requirements of a specific application. It is therefore to be understood that the present disclosure may be practiced otherwise than specifically described without departing from the scope and spirit of the present disclosure. Although examples are described above, features and/or steps of those examples may be combined, divided, omitted, rearranged, revised, and/or augmented in any desired manner. Thus, the present disclosure should be considered in all respects as illustrative and not restrictive. Accordingly, the scope of the disclosure should be determined not by the examples, but by the appended claims and their equivalents.

What is claimed is:

1. A method comprising:
receiving, at a first computing device and from a second computing device operated by a user, a request to purchase an age-restricted product;
determining, by the first computing device and based on the request to purchase the age-restricted product, a minimum age required to purchase the age-restricted product;
sending, from the first computing device and to the second computing device, a verification email address;
receiving, at the first computing device and from the second computing device, an archived email forwarded to the verification email address;
processing, by the first computing device, metadata of the archived email to determine a time the archived email was originally sent, a time the archived email was originally received, an original sender of the archived email, and an original recipient of the archived email; and
determining whether to authorize, by the first computing device, the request to purchase the age-restricted product from the user based on:
determining, by the first computing device, that the user matches at least one of the original sender of the archived email or the original recipient of the archived email;
determining, by the first computing device and based on at least one of the time the archived email was originally sent or the time the archived email was originally received, a minimum age of the archived email;
designating, by the first computing device and based on the minimum age of the archived email, a minimum age of the user; and
determining that the minimum age of the user meets or exceeds the minimum age required to purchase the age-restricted product.

2. The method of claim 1, wherein determining that the minimum age of the user meets or exceeds the minimum age comprises comparing the minimum age of the user to a predetermined threshold number of years to the minimum age required to purchase the age-restricted product.

3. The method of claim 1, wherein determining whether to authorize the request comprises determining to not authorize the request, the method further comprising sending, from the first computing device and to the second computing device, a request for supplemental information.

4. The method of claim 3, further comprising receiving, by the first computing device and from the second computing device and based on the request for supplemental information, an image of an identification card of the user.

5. The method of claim 4, further comprising estimating, by the first computing device and based on one or more facial recognition algorithms and based on the image of the identification card of the user, an age of the user.

6. The method of claim 3, further comprising receiving, by the first computing device and from the second computing device and based on the request for supplemental information, an answer to a knowledge-based authentication question.

7. The method of claim 6, wherein the knowledge-based authentication question is based on an alleged age of the user indicated by the user.

8. The method of claim 3, further comprising receiving, by the first computing device and from the second computing device and based on the request for supplemental information, an archived social media post.

9. The method of claim 8, further comprising estimating, by the first computing device and based on one or more readability level algorithms and based on the archived social media post, an age of the user.

10. The method of claim 3, further comprising determining to authorize the request based on information provided by the user in response to the request for supplemental information.

11. An apparatus, comprising:
one or more processors; and
memory storing instructions that, when executed by the one or more processors, cause the apparatus to:
receive, from a user computing device operated by a user, a request to purchase an age-restricted product;
determine, based on the request to purchase the age-restricted product, a minimum age required to purchase the age-restricted product;
send, to the user computing device, a verification email address;
receive, from the user computing device, an archived email forwarded to the verification email address;
process metadata of the archived email to determine:
a time the archived email was originally sent,
a time the archived email was originally received,
an original sender of the archived email, and
an original recipient of the archived email; and
determine whether to authorize the request to purchase the age-restricted product from the user based on:
determining that the user matches at least one of the original sender of the archived email or the original recipient of the archived email;
determining, based on at least one of the time the archived email was originally sent or the time the archived email was originally received, a minimum age of the archived email;
designating, based on the minimum age of the archived email, a minimum age of the user; and
determining that the minimum age of the user meets or exceeds the minimum age required to purchase the age-restricted product.

12. The apparatus of claim 11, the memory storing instructions that, when executed by the one or more processors, cause the apparatus to determine that the minimum age of the user meets or exceeds the minimum age by comparing the minimum age of the user to a predetermined threshold number of years to the minimum age required to purchase the age-restricted product.

13. The apparatus of claim 11, wherein determining whether to authorize the request comprises determining to not authorize the request, the memory storing instructions that, when executed by the one or more processors, cause the apparatus to send to the user computing device a request for supplemental information.

14. The apparatus of claim 13, the memory storing instructions that, when executed by the one or more processors, cause the apparatus to receive, from the user computing device and based on the request for supplemental information, an image of an identification card of the user.

15. The apparatus of claim 14, the memory storing instructions that, when executed by the one or more processors, cause the apparatus to estimate, based on one or more facial recognition algorithms and based on the image of the identification card of the user, an age of the user.

16. The apparatus of claim 13, the memory storing instructions that, when executed by the one or more processors, cause the apparatus to receive, from the user computing device and based on the request for supplemental information, an answer to a knowledge-based authentication question.

17. The apparatus of claim 16, wherein the knowledge-based authentication question is based on an alleged age of the user indicated by the user.

18. The apparatus of claim 13, the memory storing instructions that, when executed by the one or more processors, cause the apparatus to receive, from the user computing device and based on the request for supplemental information, an archived social media post.

19. The apparatus of claim 18, the memory storing instructions that, when executed by the one or more processors, cause the apparatus to estimate, based on one or more readability level algorithms and based on the archived social media post, an age of the user.

20. One or more non-transitory media storing instructions that, when executed by one or more processors, cause the one or more processors to perform steps comprising:
receive, from a user computing device operated by a user, a request to purchase an age-restricted product;
determine, based on the request to purchase the age-restricted product, a minimum age required to purchase the age-restricted product;
send, to the user computing device, a verification email address;
receive, from the user computing device, an archived email forwarded to the verification email address;
process metadata of the archived email to determine:
a time the archived email was originally sent,
a time the archived email was originally received,
an original sender of the archived email, and
an original recipient of the archived email; and
determine whether to authorize the request to purchase the age-restricted product from the user based on:
determining that the user matches at least one of the original sender of the archived email or the original recipient of the archived email;
determining, based on at least one of the time the archived email was originally sent or the time the archived email was originally received, a minimum age of the archived email;
designating, based on the minimum age of the archived email, a minimum age of the user; and
determining that the minimum age of the user meets or exceeds the minimum age required to purchase the age-restricted product.
